(19) United States
(12) Patent Application Publication
(10) Pub. No.: US 2014/0267142 A1
(43) Pub. Date: Sep. 18, 2014

(54) EXTENDING INTERACTIVE INPUTS VIA SENSOR FUSION

(71) Applicant: QUALCOMM INCORPORATED, San Diego, CA (US)

(72) Inventors: Francis B. MacDOUGALL, Toronto (CA); Andrew J. EVERITT, Cambridge (GB); Phuong L. TON, San Diego, CA (US); Virginia Walker KEATING, San Diego, CA (US); Darrell L. KRULCE, Solana Beach, CA (US)

(73) Assignee: QUALCOMM INCORPORATED, San Diego, CA (US)

(21) Appl. No.: 13/843,727

(22) Filed: Mar. 15, 2013

(51) Int. Cl. G06F 3/01; G06F 3/044

(52) U.S. Cl. CPC G06F 3/017; G06F 3/044
USPC 345/174

(57) ABSTRACT

Systems and methods according to one or more embodiments of the present disclosure are provided for seamlessly extending interactive inputs. In an embodiment, a method comprises detecting with a first sensor at least a portion of an input by a control object. The method also comprises determining that the control object is positioned in a transition area. The method further comprises determining whether to detect a subsequent portion of the input with a second sensor based at least in part on the determination that the control object is positioned in the transition area.

### TECHNICAL FIELD

The present disclosure generally relates to interactive inputs on a user device interface.

### BACKGROUND

Currently, user devices (e.g., smart phones, tablets, laptops, etc.) having interactive input capabilities such as touch screens or gesture recognition generally have small-sized screens.

Interactive inputs such as touch inputs and gestures may generally be performed over the small-sized screens (mostly by hand). However, the small-sized screens can limit an interactive input area causing the interactive inputs to be primitive and impeding interactions such as smooth swiping, scrolling, panning, zooming, etc. In some cases, current interactive inputs such as gestures may be done beside the screen, for example, by pen notations; however, this may cause disconnection between the input and an interface response.

Also, interactive inputs such as touch inputs and gestures may generally obscure the small-sized screen of the user device. For instance, current touch inputs, which are confined to the screen of the user device, may make it difficult to see affected content. As such, interactive inputs may require the user to perform repeated actions to perform a task, for example, multiple pinches, selects, or scroll motions.

Accordingly, there is a need in the art for improving interactive inputs on a user device.

### SUMMARY

According to one or more embodiments of the present disclosure, methods and systems are provided for extending interactive inputs by seamless transition from one sensor to another.

According to an embodiment, a method comprises detecting with a first sensor at least a portion of an input by a control object. The method also comprises determining that the control object is positioned in a transition area. The method further comprises determining whether to detect a subsequent portion of the input with a second sensor based at least in part on the determination that the control object is positioned in the transition area.

According to another embodiment, a method includes detecting with a first sensor attached to an electronic device at least a portion of an input by a control object. The method also includes detecting movement of the control object into a transition area or within the transition area. And the method also includes determining whether to detect a subsequent portion of the input with a second sensor attached to the electronic device based at least in part on the detected movement of the control object.

In one embodiment, the method further includes determining whether a position of the control object is likely to exceed a detection range of the first sensor. In an embodiment, the method includes determining whether the position of the control object is likely to exceed a detection range of the first sensor based on an active application. In an embodiment, the method includes determining whether the position of the control object is likely to exceed a detection range of the first sensor based on a velocity of the movement. In an embodiment, the method includes determining whether the position of the control object is likely to exceed a detection range of the first sensor based on information learned from previous inputs by a user associated with the control object.

In another embodiment, the method further includes determining whether movement of the control object is detectable with a higher confidence using the second sensor than using the first sensor.

In another embodiment, the method further includes determining whether to detect the subsequent portion of the input with a third sensor based at least in part on the detected movement of the control object.

In another embodiment, the transition area includes a first transition area, and the method further includes detecting movement of the control object into a second transition area or within the second transition area, the second transition area at least partially overlapping the first transition area.

In another embodiment, the first sensor comprises a capacitive touch sensor substantially aligned with a screen of the device, and the second sensor comprises a wide angle camera on an edge of the device or a microphone sensitive to ultrasonic frequencies. In another embodiment, the first sensor comprises a first camera configured to capture images in a field of view that is at least partially aligned with a screen of the device, and the second sensor comprises a camera configured to capture images in a field of view that is at least partially offset from the screen of the device. In another embodiment, the first sensor comprises a wide angle camera on an edge of the device or a microphone sensitive to ultrasonic frequencies, and the second sensor comprises a capacitive touch sensor substantially aligned with a screen of the device. In another embodiment, the first sensor comprises a first camera configured to capture images in a field of view at least partially aligned with an edge of the device, and the second sensor comprises a second camera configured to capture images in a field of view that is at least partially aligned with a screen of the device.

In another embodiment, the method further includes selecting the second sensor from a plurality of sensors attached to the electronic device. In an embodiment, the electronic device comprises a mobile device. In another embodiment, the electronic device comprises a television.

In another embodiment, the first or second sensor comprises a first microphone sensitive to ultrasonic frequencies disposed on a face of the electronic device, and a remaining one of the first and second sensors comprises a second microphone sensitive to ultrasonic frequencies disposed on an edge of the electronic device.

In another embodiment, the method further includes detecting the subsequent portion of the input with the second sensor, and affecting operation of an application on the electronic device based on the input and the subsequent portion of the input. In an embodiment, the method further includes time-syncing data from the first sensor and the second sensor such that the movement of the control object affects an operation substantially the same when detected with the first sensor as when detected with the second sensor. In an embodiment, the operation comprises a zoom operation, wherein the movement comprises the control object transitioning between a first area above or touching a display of the device and a second area offset from the first area. In another embodiment, the operation comprises a scroll or pan operation, wherein the movement comprises the control object transitioning between a first area above or touching a display of the device and a second area offset from the first area.

In another embodiment, the method further includes detecting a disengagement input, and ceasing to affect an operation of an application based on the detected disengagement input. In an embodiment, the movement of the control object is substantially within a plan, and the disengagement input comprises motion of the control object out of the plane. In another embodiment, the control object comprises a hand, and the disengagement input comprises a closing of the hand.

### BRIEF DESCRIPTION OF THE DRAWINGS

FIG. 1 is a diagram illustrating extending of a gesture from over-screen to off-screen according to an embodiment of the present disclosure.

FIG. 2 is a diagram illustrating extending of a gesture from off-screen to over-screen according to an embodiment of the present disclosure.

FIG. 3 is a diagram illustrating a device having a set of sensors used in conjunction to track an object according to an embodiment of the present disclosure.

FIG. 4 is a flow diagram illustrating a method for tracking a control object according to an embodiment of the present disclosure.

FIG. 5 is a diagram illustrating continuing a touch action beyond a screen of a user device according to an embodiment of the present disclosure.

FIG. 6 is a diagram illustrating continuing a touch action beyond a screen of a user device according to an embodiment of the present disclosure.

FIG. 7 is a diagram illustrating continuing a touch action beyond a screen of a user device according to another embodiment of the present disclosure.

FIG. 8 is a flow diagram illustrating a method for tracking movement of a control object according to an embodiment of the present disclosure.

FIG. 9 is a block diagram illustrating a system for implementing a device according to an embodiment of the present disclosure.

FIG. 10 is a flow diagram illustrating a method for extending interactive inputs according to an embodiment of the present disclosure.

### DETAILED DESCRIPTION

Systems and methods according to one or more embodiments of the present disclosure are provided for seamlessly extending interactive inputs such as touch and gesture recognition, for example via multimodal sensor fusion.

Sensors or technologies configured to detect non-touch inputs may be included in a user device or system and/or located on various surfaces of the user device, for example, on a top, a bottom, a left side, a right side and/or a back of the user device such that non-touch data such as gestures may be captured when they are performed directly in front of the user device (on-screen) as well as off a direct line of sight of a screen of a user device (off-screen). In general, off-screen non-touch inputs may also be referred to as “off-screen gestures” hereinafter, wherein “off-screen gestures” may refer to position or motion data of a control object such as a hand, a finger, a pen, or the like, where the control object is not touching a user device, but is proximate to the user device. Not only may these “off-screen” non-touch gestures be removed from a screen of the user device, but they may include a portion of the control object being laterally offset from the device with respect to a screen or display of a device. For example, a volume can be imagined that extends away from a display or screen of a device in a direction that is substantially perpendicular to a plane of the display or screen. “Off-screen” gestures may comprise gestures in which at least a portion of a control object performing the gesture is outside of this volume. In some embodiments, “on-screen” gestures and/or inputs may be at least partially within this volume, and may comprise touch inputs and/or gestures or non-touch inputs and/or gestures.

In one or more embodiments, on-screen (or over-screen) gesture recognition may be combined and synchronized with off-screen (or beyond screen) gesture recognition to provide a seamless user input with a continuous resolution of precision.

In an example, an action affecting content displayed on a user device such as scrolling a list, webpage, etc. may continue at a same relative content speed-to-gesture motion based on a user input, for example, based on the speed of a detected gesture including a motion of a control object (e.g. a hand, pen, finger, etc.). That is, when a user is moving his or her hand, for example in an upward motion, content such as a list, webpage, etc., is continuing to scroll at a constant speed if the user's speed of movement is consistent. Alternatively, a user may have a more consistent experience wherein the speed of an action, for example, the speed of scrolling, is not always the same. For example, scrolling speed may optionally increase based on the detected gesture including a motion of a control object (e.g., a hand, pen, finger, etc.) such that if the control object is moving more rapidly than the scrolling speed, the scrolling speed may increase. Thus, there may be a correlation of the speed of an action to the device response, such as scrolling, performed on a user device. Thus, in some embodiments, the reaction of the device to a movement of the user is consistent regardless of where any given portion of a gesture is being defined (e.g., whether a user is touching a display of the device or has slid a finger off of the display).

Also, in one or more embodiments, touch or multi-touch actions may be continued or extended off-screen via integrating touch sensor data with touchless gesture data. Notably, touch or multi-touch actions may not be performed simultaneously with gestures, instead, a soft pass is effected such that the touch or multi-touch actions are continued with gestures. In this regard, a touch action or input may initiate off-screen gesture detection using techniques for tracking gestures off-screen, for example, ultrasound, wide angle image capturing devices (e.g., cameras) on one or more edges of a user device, etc.

As such, touch input-sensing data may be combined with gesture input-sensing data to create one continuous input command. Such data sets may be synchronized to provide a seamless user input with a continuous resolution of precision. Also, the data sets may be conjoined to provide a contiguous user input with a varied resolution of precision. For example, a sensor adapted to detect gesture input-sensing data may have a different resolution of precision than an input adapted to detect touch input-sensing data in some embodiments. In some embodiments, finer gestures may produce an effect when being detected with a first sensor modality than when being detected with a second sensor modality.

In various embodiments, a transition area or region may be identified, for example, where there is a handoff from one sensor to another such that the precision of a gesture may remain constant. In an example where there may be a transition region from a camera to an ultrasound sensor, there may not be any jerking of a device response to user input, that is, a seamless response may be provided between sensors such that a continuous experience may be created for a user of the device. In this case, two different sensors or technologies, e.g., a camera and an ultrasound sensor, may sense the same interactive input (e.g., a touchless gesture). As such, when moving from one area to another, sensor inputs are matched so that a seamless user experience is achieved. Multi-sensor transitions may include going from sensor to sensor such as from a camera to an ultrasound sensor, from an ultrasound sensor to a camera or another sensor, etc. In one or more embodiments, a handoff in a transition area or region may be a soft handoff where the sensors may be used at the same time. In another embodiment, a handoff in a transition area or region may occur from one sensor to another such that there is a hard handoff between sensors, that is, one sensor may be used after detection has been completed by another sensor, or after one sensor is turned off.

Advantageously, embodiments herein may create more interaction area on a screen of a user device, user input commands may be expanded, occlusion of a screen may be avoided, primary interaction may be extended, for example by reducing or replacing repeated touch commands, and/or smoother interaction experiences such as zooming, scrolling, etc. may be created.

Referring now to FIG. 1, a diagram illustrates extending a gesture from over-screen to off-screen according to an embodiment of the present disclosure.

In various embodiments, a user may use an over-screen to off-screen gesture for various purposes for affecting content such as swiping, scrolling, panning, zooming, etc. A user may start a gesture, for example by using an open hand 102 over a screen of a user device 104 in order to affect desired on-screen content. The user may then continue the gesture off the screen of the user device 104 as illustrated by reference numeral 106 to continue to affect the on-screen content. In this example, the user may move the open hand 102 towards the right of the screen of user device 104 to continue the gesture. In various examples, the user may continue the gesture off the user device such that the open hand 102 is not in the line of sight (i.e., not in view) of the screen of user device 104. Stopping the gesture may stop affecting the content. Optionally, the user may perform a disengaging gesture to stop tracking of the current gesture.

In another example, the user may use an over-screen to off-screen gesture for scrolling a list. To begin, the user may move a hand, for example an open hand, over a screen of the user device such that an on-screen list scrolls. Then, the user may continue to move the hand up and beyond the user device to cause the on-screen list to continue to scroll at the same relative speed-to-motion. In some embodiments, the velocity of the gesture may be taken into account and there may be a correlation between the speed of movement and the speed of the action performed (e.g., scrolling faster). Similarly, matching a location of a portion of displayed content to a position of a control object may produce the same effect in some embodiments such that the quicker a user moves the control object the quicker a scroll appears to be displayed. When the hand movement is stopped, the scrolling may be stopped. Optionally, a disengaging gesture may be detected, for example a closed hand, and tracking of the current gesture stopped in response thereto. In other embodiments, if the hand movement has scrolled off-screen, stopped moving, or is at a set distance from the user device, the action (e.g., scrolling) may continue until the hand is no longer detected.

In a further example, the user may use an over-screen to off-screen gesture for zooming a map. To begin, the user may put two fingers together over a screen of the user device (on one or two hands). Then, the user may move the fingers apart such that an on-screen map zooms in. The user may continue to move the fingers apart, with at least one finger beyond the user device, to cause the on-screen map to continue to zoom at the same relative speed-to-motion. Stopping the fingers at any point stops the zooming. Optionally, the user may perform a disengaging gesture to stop tracking of the current gesture.

Referring now to FIG. 2, a diagram illustrates extending a gesture from off-screen to over-screen according to an embodiment of the present disclosure.

An off-screen to over-screen gesture may be used for various purposes for affecting content such as swiping, scrolling, panning, zooming, etc. In this embodiment, a user may start a gesture, for example by using an open hand 202 off a screen of a user device 204 (e.g., out of the line of sight of the screen of user device 204). In various embodiments, off-screen gesture detection and tracking may be done by using techniques such as ultrasound, wide angle image capturing devices (e.g., cameras such as a visible-light camera, a range imaging camera such as a time-of-flight camera, structured light camera, stereo camera, or the like), IR, etc. on one or more edges of the user device, etc. The user may then continue the gesture over the user device as illustrated by reference numeral 206 to continue to affect the on-screen content. In this example, the user may move the open hand 202 towards the screen of user device 204 on the left to continue the gesture. Stopping the gesture may stop affecting of the content. Optionally, the user may perform a disengaging gesture to stop tracking of the current gesture.

In another example, the user may use an off-screen to over-screen gesture for scrolling a list. To begin, the user may perform an off-screen gesture such as a grab gesture below a user device. The user may then move the hand upwards such that an on-screen list scrolls. Then, the user may continue to move the hand up over the user device to cause the on-screen list to continue to scroll at the same relative speed-to-motion. In some embodiments, the velocity of the gesture may be taken into account and there may be a correlation between the speed of movement with the speed of the action performed (e.g., scrolling faster). Stopping the hand movement at any point may stop the scrolling. Optionally, the user may perform a disengaging gesture to stop tracking of the current gesture. Referring now to FIG. 3, a diagram illustrates a device having a set of sensors used in conjunction to track an object according to an embodiment of the present disclosure.

A set of sensors (e.g., speakers) may be mounted on a device 302 in different orientations and may be used in conjunction to smoothly track an object such as an ultrasonic pen or finger. Speakers may detect ultrasound emitted by an object such as a pen or other device, or there may be an ultrasound emitter in the device and the speakers may detect reflections from the emitter(s). In various embodiments, sensors may include speakers, microphones, electromyography (EMG) strips, or any other sensing technologies. In various embodiments, gesture detection may include ultrasonic gesture detection, vision-based gesture detection (e.g., via camera or other image or video capturing technologies), ultrasonic pen gesture detection, etc. In various embodiments, a camera may be a visible-light camera, a range imaging camera such as a time-of-flight camera, structured light camera, stereo camera, or the like.

The embodiment of FIG. 3 may be an illustration of gesture detection and tracking technology comprising a control object, for example an ultrasonic pen or finger used over and on one or more sides of the device 302. In various embodiments, one or more sensors may detect an input by the control object (e.g., an ultrasonic pen, finger, etc.) such that when the control object is determined to be positioned in a transition area, it may be determined whether to detect a subsequent portion of the input with another sensor based at least in part on the determination that the control object is positioned in the transition area. The transition area may include an area where there is a handoff from one sensor to another or where there are multi-sensor transitions that may include going from sensor to sensor such as from a camera to an ultrasound sensor, from an ultrasound sensor to a camera or to another sensor, etc. That is, in various embodiments, where a transition area or region is identified, the precision of the input may remain constant such that there may not be any jerking, but a continuous motion may be used, thus providing a seamless user experience. In various embodiments, a transition area may include a physical area where multiple sensors may detect a control object at the same time. A transition area may be of any shape, form or size, for example, a planar area, a volume, or it may be of different sizes or shapes depending on different properties of the sensors. Furthermore, multiple transition areas may overlap. In that regard, a selection from any on of the sensors which are operative in the overlapping transition area may be made in some embodiments. In other embodiments, a decision is made individually for each transition area until a single sensor (or a plurality of sensors in some embodiments) is selected. For example, when two transition areas overlap, a decision of which sensor to use may be made for a first of the two transition areas, and then subsequently for a second of the two transition areas in order to select a sensor.

Front sensors 304 may be used for tracking as well as side sensors 306 and top sensors 308. In an example, front sensors 304 and side sensors 306 may be used in conjunction to smoothly track a control object such as an ultrasonic pen or finger as will be described in more detail below with respect to FIG. 4 according to an embodiment.

In one or more embodiments, quality of data may be fixed by using this configuration of sensors. In an example, front facing data from front sensors 304 may be used. The front facing data may be maintained if it is of acceptable quality; however, if the quality of the front facing data is poor, then side facing data from side sensors 306 may be used in conjunction. That is, the quality of the front facing data may be evaluated and if its quality is poor (e.g., only 20% or less of sound or signal is detected by front sensors 304 alone), or a signal is noisy due to, for example, ambient interference, partially blocked sensors or other causes, then a transition may be made to side facing data, which may improve the quality of data, for example to 60% (e.g., a higher percentage of the reflected sound or signal may be detected by side sensors 306 instead of using front sensors 304 alone). It should be noted that the confidence value for a result may be increased by using additional sensors. As an example, a front facing sensor may detect that the control object, such as a finger, is at a certain distance, e.g., 3 cm to the side and forward of the device, which may be confirmed by the side sensors to give a higher confidence value for the determined result, and hence better quality of tracking using multiple sensors in transition areas. The transition or move from front to side may be smoothly done by simply using the same control object (e.g., pen or finger) from front to side, for example. The move is synchronized such that separate control objects, e.g., two pens or fingers, are not required. In an example, a user's input such as a hand gesture for controlling a volume on device 302 may be detected by front sensors 304, e.g. a microphone; as the user moves his hand up so as to move past a top edge of the device 302, the hand may be detected by the top sensors 308 (e.g. microphones) while in a transition area between the sensors 304 and 308 and once the hand moves beyond range of the sensors 304. Similarly, movement to a side of the device 302 may activate or initiate sensors 306 such that the hand may be detected by side sensors 306, for example. In various embodiments, each of the sensors 304, 306, 308 may include any appropriate sensor such as speakers, microphones, electromyography (EMG) strips, or any other sensing technologies.

Referring now to FIG. 4, a flow diagram illustrates a method for tracking a control object according to an embodiment of the present disclosure. The method of FIG. 4 may be implemented by the device illustrated in the embodiment of FIG. 3, illustrating gesture detection and tracking technology comprising a control object such as an ultrasonic pen or finger that may be used over and on one or more sides of the device.

In block 402, a device (e.g., a device 302 illustrated in FIG. 3) may include sensors (e.g., speakers, microphones, etc.) on various positions such as front facing sensors 304, side facing sensors 306, top facing sensors 308, etc. In over-screen gesture recognition mode, over-screen gestures may be recognized by one or more front facing sensors 304.

In block 404, data may be captured from the front facing sensors 304, e.g., microphones, speakers, etc.

In block 406, the captured data from the front facing sensors 304 may be processed for gesture detection, for example by the processing component 1504 illustrated in FIG. 9.

In block 408, it is determined whether a control object such as a pen or finger is detected, for example by the processing component 1504.

In block 410, if a control object such as a pen or finger is detected, a finger or pen gesture motion may be captured by the front facing sensors 304, e.g., microphones, speakers, etc.

In block 412, the front-facing gesture motion may be passed to a user interface input of device 302, for example by the processing component 1504 or a sensor controller or by way of communication between subsystems associated with the sensors 304 and the sensors 302.

In block 414, capture of data from side facing sensors 306 (e.g., microphones, speakers, etc.) may be initiated.

In block 416, the captured data from the side facing sensors 306 may be processed for gesture detection, for example by the processing component 1504.

In block 418, it is determined whether a control object such as a pen or finger is detected from side-facing data captured from the side facing sensors 306. If not, the system goes back to block 404 so that data may be captured from the front facing sensors 304, e.g., microphones, speakers, etc.

In block 420, if a control object such as a pen or finger is detected from the side-facing data captured from the side facing sensors 306, the side-facing data may be time-synchronized with the front-facing data captured from the front facing sensors 304, thus creating one signature. In an embodiment, there may be a transition region from front facing sensors 304 to side facing sensors 306, such that there may not be any jerking of a response by the device 302, that is, a seamless response may be provided between the sensors such that a continuous input by the control object may cause a consistent action on device 302. In this case, different sensors or technologies, e.g., front facing sensors 304 and side facing sensors 306 may sense the same input by a control object (e.g., a touchless gesture). As such, when moving the control object from one area to another, such as from front to side of device 302, the sensor inputs (e.g., 304, 306, 308) may be synchronized so that a seamless user experience is achieved.

In block 422, it is determined whether a control object such as a pen or finger is detected from front-facing data. If a control object such as a pen or finger is detected from front-facing data, the system goes back to block 404 so that data may be captured from the front facing sensors 304.

In block 422, if a control object such as a pen or finger is not detected from front-facing data, e.g., data captured by front facing sensors 304, it is determined whether a control object such as a pen or finger is detected from side-facing data. If yes, then side-facing gesture motions may be passed to a user interface input as a continuation of the front-facing gesture motion.

In one or more embodiments, when a control object is detected in a transition area going, for example, from the front facing sensors 304 to the side facing sensors 306, the side facing sensors 306 may detect whether the control object is in its detection area. In other embodiments, the front facing sensors 304 may determine a position of the control object and then determine whether the control object is entering a transition area, which may be at an edge of where the control object may be detected by the front facing sensors 304, or in an area where the front facing sensors 304 and the side facing sensors 306 overlap. In still other embodiments, the side facing sensors 306 may be selectively turned on or off based on determining a position of the control object, or based on a determination of motion, for example, determining whether the control object is moving in such a way (in the transition area or toward it) that it is likely to enter a detection area of the side facing sensors 306. Such determination may be based on velocity of the control object, a type of input expected by an application that is currently running, learned data from past user interactions, etc.

Referring now to FIG. 5, a diagram illustrates continuing a touch action beyond a screen of a user device according to an embodiment of the present disclosure.

A user 502 may start a touch action, for example, by placing a finger on a screen of a user device 504, which may be detected by a touch sensor of user device 504. Such touch action may be for the purpose of scrolling a list, for example. Conveniently, user 502 may continue scrolling beyond the screen of user device 502 such that as the user's finger moves upwards as indicated by reference numeral 506 a handoff is made from touch sensor to an off-screen gesture detection sensor of user device 504. A smooth transition is made from the touch sensor that is configured to detect the touch action to the off-screen gesture detection sensor that is configured to detect a gesture off the screen that may be out of the line of sight of the screen of user device 504 In this regard, a transition area from the touch sensor to the off the screen gesture detection sensor may be near the edge of the screen of user device 504, or within a detection area where the gesture off the screen may be detected, or within a specified distance, for example, within 1 cm. of the screen of user device 504, etc. In an embodiment, user inputs such as touch actions and gestures off the screen may be combined. In another embodiment, a user input may be selectively turned on or off based on the type of sensors, etc.

In various embodiments, off-screen gesture detection and tracking may be done by using techniques such as ultrasound, wide angle image capturing devices (e.g., cameras) on one or more edges of the user device, etc. As illustrated in the embodiment of FIG. 5, a continued gesture by the user may be detected over the user device as illustrated by reference numeral 506, which may continue to affect the on-screen content. Stopping the gesture may stop affecting of the content. Optionally, a disengaging gesture by the user may be detected, which may stop tracking of the current gesture.

Continuing a touch action with a gesture may be used for various purposes for affecting content such as swiping, scrolling, panning, zooming, etc.

According to one or more embodiments of the present disclosure, various technologies may be used for extending interactive inputs via sensor fusion. In that regard, any gesture technologies may be combined with touch input technologies. Such technologies may include, for example: ultrasonic control object detection technologies from over screen to one or more sides; vision-based detection technologies from over screen to one or more sides; onscreen touch detection technologies to ultrasonic gesture detection off-screen; onscreen touch detection technologies to vision-based gesture detection off-screen, etc. In various embodiments, onscreen detection may include detection of a control object such as a finger or multiple fingers touching a touchscreen of a user device. In some embodiments, touchscreens may detect objects such as a stylus or specially coated gloves. In one or more embodiments, onscreen may not necessarily mean a user has to be touching the device. For example, vision-based sensors and/or a combination with ultrasonic sensors may be used to detect an object, such as a hand, finger(s), a gesture, etc., and continue to track the object off-screen where a handoff between the sensors appears seamless to the user.

Referring now to FIG. 6, a diagram illustrates continuing a touch action beyond a screen of a user device according to an embodiment of the present disclosure.

In this example of FIG. 6, a user may play a video game such as Angry Birds™. The user wants to aim a bird at the obstacle. The user touches the screen of user device 604 with a finger 602 to select a slingshot as presented by the game. The user then pulls the slingshot back and continues to pull the slingshot off-screen as illustrated by reference numeral 606 in order to find the right angle and/or distance to retract an element of the game while keeping the thumb and forefinger pressed together or in close proximity. Once the user finds the right angle or amount of retraction off-screen, the user may separate his thumb and forefinger. One or more sensors configured to detect input near an edge of the device 604, for example a camera on the left edge of the device 604 as illustrated in FIG. 6, may detect both the position of the fingers and the point at which the thumb and forefinger are separated. When such separation is detected, the game element may be released toward the obstacle.

Referring now to FIG. 7, a diagram illustrates continuing a touch action beyond a screen of a user device according to an embodiment of the present disclosure.

In this example of FIG. 7, a user may want to find a place on a map displayed on a screen of a user device 704. The user may position both fingers 702 on a desired zoom area of the map. The user then moves the fingers 702 away from each other as indicated by reference numeral 706 to zoom. The user may continue interaction off-screen until the desired zoom has been obtained.

Referring now to FIG. 8, a flow diagram illustrates a method for tracking movement of a control object according to an embodiment of the present disclosure. In various embodiments, the method of FIG. 8 may be implemented by a system or a device such as devices 104, 204, 304, 504, 604, 704 or 1500 illustrated in FIG. 1, 2, 3, 5, 6, 7 or 9, respectively.

In block 802, a system may respond to a touch interaction. For example, the system may respond to a user placing a finger(s) on a screen, i.e., touching the screen of a user device such as device 604 of FIG. 6 or device 704 of FIG. 7, for example.

In block 804, sensors may be activated. For example, ultrasonic sensors on a user device may be activated as the user moves the finger(s) towards the screen bezel (touch). For example, as illustrated in FIG. 6, sensors such as ultrasonic sensors located on a left side of device 604 may be activated in response to detecting the user's fingers moving towards the left side of the screen of device 604.

In block 806, sensors on one or more surfaces of the user device detect off-screen movement. For example, one or more ultrasonic sensors located on a side of the user device may detect off-screen movement as the user moves the finger(s) off-screen (hover). In one example, the sensors located on a left side of device 604 of FIG. 6 may detect the user's off-screen movement of his or her fingers.

In block 808, detecting of finger movement off-screen may be stopped. In this regard, the user may tap off-screen to end off-screen interaction. In other embodiments, off-screen detection may be stopped when a disengagement gesture or motion is detected, for example, closing of an open hand, opening of a closed hand, or, in the case of a motion substantially along a plane such as a plane of a screen of a user device (e.g., to pan, zoom, etc.), moving a hand out of the plane, etc.

In various embodiments, the system may respond to another touch interaction. For example, the user may return to touch the screen.

Referring now to FIG. 9, a block diagram of a system for implementing a device is illustrated according to an embodiment of the present disclosure.

It will be appreciated that the methods and systems disclosed herein may be implemented by or incorporated into a wide variety of electronic systems or devices. For example, a system 1500 may be used to implement any type of device including wired or wireless devices such as a mobile device, a smart phone, a Personal Digital Assistant (PDA), a tablet, a laptop, a personal computer, a TV, or the like. Other exemplary electronic systems such as a music player, a video player, a communication device, a network server, etc. may also be configured in accordance with the disclosure.

System 1500 may be suitable for implementing embodiments of the present disclosure, including user devices 104, 204, 302, 504, 604, 704, illustrated in respective Figures herein. System 1500, such as part of a device, e.g., smart phone, tablet, personal computer and/or a network server, includes a bus 1502 or other communication mechanism for communicating information, which interconnects subsystems and components, including one or more of a processing component 1504 (e.g., processor, micro-controller, digital signal processor (DSP), etc.), a system memory component 1506 (e.g., RAM), a static storage component 1508 (e.g., ROM), a network interface component 1512, a display component 1514 (or alternatively, an interface to an external display), an input component 1516 (e.g., keypad or keyboard, interactive input component such as a touch screen, gesture recognition, etc.), and a cursor control component 1518 (e.g., a mouse pad).

In accordance with embodiments of the present disclosure, system 1500 performs specific operations by processing component 1504 executing one or more sequences of one or more instructions contained in system memory component 1506. Such instructions may be read into system memory component 1506 from another computer readable medium, such as static storage component 1508. These may include instructions to extend interactions via sensor fusions, etc. For example, user input data that may be detected by a first sensor (e.g., a touch action that may be detected via a touch screen, or an on-screen gesture that may be detected via gesture recognition sensors implemented by input component 1516), may be synchronized or combined by a processing component 1504 with user input data that may be detected by a second sensor (e.g., an off-screen gesture that may be detected via gesture recognition sensors implemented by input component 1516) when the user input data is detected within a transition area where a smooth handoff from one sensor to another is made. In that regard, processing component 1504 may also implement a controller that may determine when to turn sensors on or off as described above, and/or when an object is within a transition area and/or when to hand the control object off between sensors. In some embodiments, the input component 1516 comprises or is used to implement one or more of the sensors 304, 306, 308 In other embodiments, hard-wired circuitry may be used in place of or in combination with software instructions for implementation of one or more embodiments of the disclosure.

Logic may be encoded in a computer readable medium, which may refer to any medium that participates in providing instructions to processing component 1504 for execution. Such a medium may take many forms, including but not limited to, non-volatile media, volatile media, and transmission media. In various implementations, volatile media includes dynamic memory, such as system memory component 1506, and transmission media includes coaxial cables, copper wire, and fiber optics, including wires that comprise bus 1502. In an embodiment, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read. The computer readable medium may be non-transitory.

In various embodiments of the disclosure, execution of instruction sequences to practice the disclosure may be performed by system 1500. In various other embodiments, a plurality of systems 1500 coupled by communication link 1520 (e.g., Wi-Fi, or various other wired or wireless networks) may perform instruction sequences to practice the disclosure in coordination with one another. System 1500 may receive and extend inputs, messages, data, information and instructions, including one or more programs (i.e., application code) through communication link 1520 and network interface component 1512. Received program code may be executed by processing component 1504 as received and/or stored in disk drive component 1510 or some other non-volatile storage component for execution.

Referring now to FIG. 10, a flow diagram illustrates a method for extending interactive inputs according to an embodiment of the present disclosure. It should be appreciated that the method illustrated in FIG. 10 may be implemented by system 1500 illustrated in FIG. 9, which may implement any of user devices 104, 204, 302, 504, 604, 704, illustrated in respective Figures herein according to one or more embodiments.

In block 1002, a system, e.g., system 1500 illustrated in FIG. 9, may detect, with a first sensor, at least a portion of an input by a control object. Input component 1516 of system 1500 may implement one or more sensors configured to detect user inputs by a control object including touch actions on a display component 1514, e.g., a screen, of a user device, or gesture recognition sensors (e.g., ultrasonic). In various embodiments, a user device may include one or more sensors located on different surfaces of the user device, for example, in front, on the sides, on top, on the back, etc. (as illustrated, for example, by sensors 304, 306, 308 on user device 302 of the embodiment of FIG. 3). A control object may include a user's hand, a finger, a pen, etc. that may be detected by one or more sensors implemented by input component 1516.

In block 1004, the system may determine that the control object is positioned in a transition area. Processing component 1504 may determine that detected input data is indicative of the control object being within a transition area, for example, when the control object is detected near an edge of the user device, or within a specified distance offset of a screen of the user device (e.g., within 1 cm). A transition area may include an area where there is continuous resolution of precision for inputs during handoff from one sensor to another sensor. In some embodiments, transition areas may also be located at a distance from a screen of from the device, for example where a sensor with a short range hands off to a sensor with a longer range.

In block 1006, the system may determine whether to detect a subsequent portion of the same input with a second sensor based at least in part on the determination that the control object is positioned in the transition area. In an embodiment, processing component 1504 may determine that a subsequent portion of a user's input, for example, a motion by a control object, is detected in the transition area. As a result, a gesture detection sensor implemented by input component 1516 may then be used to detect an off screen gesture to continue the input in a smooth manner.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method comprising:
detecting with a first sensor at least a portion of an input by a control object;
determining that the control object is positioned in a transition area; and
determining whether to detect a subsequent portion of the same input with a second sensor based at least in part on the determination that the control object is positioned in the transition area.

2. The method of claim 1, wherein the transition area further comprises an area where there is continuous resolution of precision for inputs during handoff from at least the first sensor to the second sensor.

3. The method of claim 1, wherein:
the detecting comprises capturing, by a user device, on-screen input data; and wherein the method further comprises:
combining the on-screen input data with off-screen data to provide a seamless user input when it is determined to detect the subsequent portion of the input with the second sensor.

4. The method of claim 3, wherein the capturing the on-screen input data further comprises capturing touchless gesture input data above a screen, and the off-screen data further comprises off-screen touchless gesture input data, wherein the method further comprises synchronizing the touchless gesture input data captured above the screen with the off-screen touchless gesture input data.

5. The method of claim 3, wherein the capturing the on-screen input data further comprises capturing on-screen touch input data and the off screen data further comprises touchless gesture data, the method further comprising: controlling an action via combining the on-screen touch input data with the touchless gesture data.

6. The method of claim 5, wherein the combining the on-screen touch input data with the touchless gesture data creates one continuous command.

7. The method of claim 1, further comprising: initiating off-screen gesture detection upon determining that the control object is positioned in the transition area.

8. The method of claim 7, wherein the off-screen gesture detection further comprises using ultrasound or one or more wide angle image capturing devices on one or more edges of a user device.

9. The method of claim 8, further comprising capturing on-screen input data using a touchscreen or a forward-facing image sensor on the user device.

10. The method of claim 1, further comprising using both the first sensor and the second sensor to detect input from the control object while the control object is positioned within the transition area.

11. The method of claim 1, wherein the detecting further comprises capturing, by a user device, off-screen input data; and wherein the method further comprises:
combining the off-screen input data with on-screen data to provide a seamless user input when it is determined to detect the subsequent portion of the input with the second sensor.

12. The method of claim 11, wherein the capturing the off-screen input data further comprises capturing off-screen touchless gesture input data, and the on-screen data further comprises on-screen touchless gesture input data, wherein the method further comprises synchronizing the off-screen touchless gesture input data with the on-screen touchless gesture input data.

13. A system comprising:
a plurality of sensors configured to detect one or more inputs;
one or more processors; and
one or more memories adapted to store a plurality of machine-readable instructions which when executed by the one or more processors are adapted to cause the system to:
detect with a first sensor of the plurality of sensors at least a portion of an input by a control object;
determine that the control object is positioned in a transition area; and
determine whether to detect a subsequent portion of the input with a second sensor of the plurality of sensors based at least in part on the determination that the control object is positioned in the transition area.

14. The system of claim 13, wherein the transition area further comprises an area where there is continuous resolution of precision for inputs during handoff from at least the first sensor to the second sensor.

15. The system of claim 13, wherein the plurality of machine-readable instructions which when executed by the one or more processors are adapted to cause the system to:
capture on-screen input data with the first sensor; and
combine the on-screen input data with off-screen input data captured with the second sensor to provide a seamless input when it is determined to detect the subsequent portion of the input with the second sensor.

16. The system of claim 15, wherein the plurality of machine-readable instructions which when executed by the one or more processors are adapted to cause the system to: capture the on-screen input data using a touchscreen or a forward-facing sensor of a user device.

17. The system of claim 15, wherein the on-screen input data further comprises touchless gesture input data captured above a screen, and the off-screen input data further comprises off-screen touchless gesture input data, wherein the plurality of machine-readable instructions which when executed by the one or more processors are adapted to cause the system to: synchronize the touchless gesture input data captured above the screen with the off-screen touchless gesture input data.

18. The system of claim 15, wherein the on-screen input data further comprises on-screen touch input data and the off input screen data further comprises touchless gesture data, wherein the plurality of machine-readable instructions which when executed by the one or more processors are adapted to cause the system to:
control an action via combining the on-screen touch input data with the touchless gesture data.

19. The method of claim 18, wherein the plurality of machine-readable instructions which when executed by the one or more processors are adapted to cause the system to: create one continuous command by the combining the on-screen touch input data with the touchless gesture data.

20. The system of claim 13, wherein the plurality of machine-readable instructions which when executed by the one or more processors are adapted to cause the system to: initiate off-screen gesture detection upon determining that the control object is positioned in the transition area.

21. The system of claim 20, wherein the plurality of machine-readable instructions which when executed by the one or more processors are adapted to cause the system to: initiate the off-screen gesture detection upon determining that the control object is positioned in the transition area by using ultrasound or one or more wide angle image capturing devices on one or more edges of a user device.

22. The system of claim 13, wherein the plurality of machine-readable instructions which when executed by the one or more processors are adapted to cause the system to: use both the first sensor and the second sensor to detect input from the control object while the control object is positioned within the transition area.

23. The system of claim 13, wherein the plurality of machine-readable instructions which when executed by the one or more processors are adapted to cause the system to:
capture off-screen input data with the first sensor; and
combine the off-screen input data with on-screen data captured with the second sensor to provide a seamless user input when it is determined to detect the subsequent portion of the input with the second sensor.

24. The system of claim 23, wherein the off-screen input data further comprises off-screen touchless gesture input data, and the on-screen data further comprises on-screen touchless gesture input data, wherein the plurality of machine-readable instructions which when executed by the one or more processors are adapted to cause the system to: synchronize the off-screen touchless gesture input data with the on-screen touchless gesture input data.

25. An apparatus comprising:
first means for detecting at least a portion of an input by a control object;
means for determining that the control object is positioned in a transition area; and
means for determining whether to detect a subsequent portion of the same input with a second means for detecting based at least in part on the determination that the control object is positioned in the transition area.

26. The apparatus of claim 25, wherein the transition area further comprises an area where there is continuous resolution of precision for inputs during handoff from at least the first means for detecting to the second means for detecting.

27. The apparatus of claim 25, wherein:
the first means for detecting further comprises means for capturing on-screen input data; and the apparatus further comprises means for combining the on-screen input data with off-screen data to provide a seamless user input when it is determined to detect the subsequent portion of the input with the second means for detecting.

28. The apparatus of claim 27, wherein the means for capturing the on-screen input data further comprises means for capturing touchless gesture input data above a screen, and the off-screen data further comprises off-screen touchless gesture input data, wherein the apparatus further comprises means for synchronizing the touchless gesture input data with the off-screen touchless gesture input data.

29. The apparatus of claim 27, wherein the means for capturing the on-screen input data further comprises means for capturing on-screen touch input data and the off screen data further comprises touchless gesture data, the apparatus further comprising: means for controlling an action via combining the on-screen touch input data with the touchless gesture data.

30. The apparatus of claim 29, further comprising means for creating one continuous command by using means for combining the on-screen touch input data with the touchless gesture data.

31. The apparatus of claim 25, further comprising: means for initiating a means for detecting off-screen gestures upon determining that the control object is positioned in the transition area.

32. The apparatus of claim 31, wherein the means for detecting off-screen gestures further comprises using ultrasound or one or more wide angle image capturing devices on one or more edges of a user device.

33. The apparatus of claim 32, further comprising means for capturing on-screen input data using a touchscreen or a forward-facing sensor on a user device.

34. The apparatus of claim 25, wherein both the first means for detecting and the second means for detecting are used to detect input from the control object while the control object is positioned within the transition area.

35. The apparatus of claim 25, wherein:
the first means for detecting further comprises means for capturing off-screen input data, and the apparatus further comprises:
means for combining the off-screen input data with on-screen data to provide a seamless user input when it is determined to detect the subsequent portion of the input with the second means for detecting.

36. The apparatus of claim 35, wherein the means for capturing the off-screen input data further comprises means for capturing off-screen touchless gesture input data, and the on-screen data further comprises on-screen touchless gesture input data, wherein the apparatus further comprises means for synchronizing the off-screen touchless gesture input data with the on-screen touchless gesture input data.

37. A non-transitory computer readable medium on which are stored computer readable instructions which, when executed by a processor, cause the processor to:
detect with a first sensor at least a portion of an input by a control object;
determine that the control object is positioned in a transition area; and
determine whether to detect a subsequent portion of the input with a second sensor based at least in part on the determination that the control object is positioned in the transition area.
